(19) United States
(12) Patent Application Publication
(10) Pub. No.: US 2012/0312239 A1
(43) Pub. Date: Dec. 13, 2012

(54) Expandable pet device

(76) Inventor: Donald Kevin Wedertz, San Mateo, CA (US)

(21) Appl. No.: 13/374,887

(22) Filed: Jan. 20, 2012

Related U.S. Application Data
(63) Continuation-in-part of application No. 12/660,298, filed on Feb. 24, 2010, now abandoned.

(51) Int. Cl. A01K 15/02; A01K 29/00

(52) U.S. Cl. 119/28.5; 119/174; 119/706

(57) ABSTRACT

This expandable pet device exudes distinct versatilities for the owner while distracting felines and other small pets away from destructive tugs on home furnishings when stretching and exercising. Distinctions depict a base for supporting one or more hollow cylinders that employ an integral telescoping tube. The base can optionally interlock with other bases for widening purposes. A modular collar fits atop the telescoped tube for a platform or remains off to allow a hinged-cylinder to encapsulate the telescoped tube for converting the structure into a cat tree. Platforms can be inserted into collars at various elevations on the post, swivel in 360 degrees and support other common enclosures like condos. Replaceable platform coverings provide two useable surfaces as a “top surface” for maximum usage. Any type of replaceable fibrous material can cover each member. This device is light-weight, sturdy and easily portable.

### BACKGROUND

Many claw posts and scratch posts are well suited for training felines and other small animals to remain off-of home furnishings when they play, exercise and climb indoors, however their utility usefulness lacks multi-functions for versatility purposes. A multi-functioning device features parts that exhibit two more functions to result in a structural design that provides an owner with versatilities that prolong terms of use.

Though millions of devices in various sizes are used globally, cited U.S. Pat. No. 4,177,763 A by Weldon R. Cook . . . U.S. Pat. No. 5,884,586 A by Peter Feldman . . . 2002/0179021A1 by A1 DeRaspe-Bolles et al . . . 2003/0017300A1 by Monica DeRaspe-Bolles, Barry G. Moore . . . U.S. Pat. No. 6,619,237 B2 by Nita J. Robertson . . . U.S. Pat. No. 6,966,277 B2 by DeRaspe-Bolles et al . . . and 2005/0263096A1 by Frank P. Mita, Jerry L. Kohli offer functional designs for pet training but, are limited in exhibiting a device that utilizes parts, wherein each part renders multi-functions within such structure. Such a device would exhibit a vertical post that features an adjustable height mechanism beyond simply standing upright and support platforms. Another example for using the same vertical post would be as a horizontal member as a bridge that conjoins two vertical posts together for a feline to run or jump safely from post to post. This same device would include a base that can be changed-out for a larger or smaller one.

Even though all the above cited patents use carpet or other fibrous materials to cover their devices, the cover for a platform should be designed to affect a usefulness of the lower and upper surfaces as a top surface for the feline to claw and rest on. Additionally, carpets that cover a vertical post should also be cross utilized to cover other claw posts' worn surface, provided their structures are useable.

### SUMMARY

This invention is comprised of numerous parts that feature multi-functioning purposes that many owners would appreciate when training domestic-

[symbol]

A coupler or similar device; that positions a post, can be affixed to the base so a cylindrical member can stand upright or multiple couplers can be added to the base to support a plurality of cylindrical members. After a cylindrical member is secured, an inner structure can be manually telescoped to a predetermined height. Common hardware holds the cylindrical's lower end to the base, to control side ways and fore-aft swaying movements.

Any fibrous material that covers the post and platform can offer multiple functions beyond being replaceable and coordinating with the rooms color and decor. The post cover can be cross utilized to cover an existing post's tattered surface, rather than disposing the entire structure or manually pulling the worn material away from the underlying post to staple new material on. The pulling off action requires a lot of manual effort with hand pliers and heavy duty scissors. One slip of the hand pliers upwards; towards a face or other extremity of the body, could result in a serious injury. Additionally, the upper and lower surface of the platform cover can be used as a “top surface” to maximize its usefulness rather than pulling more carpet off with hand pliers.

When this invention is inventoried in a store, it is delivered unassembled within a wrapped plastic sheeting that holds the cylindrical members; with their carpet or fibrous cover on, and next to platforms that will have their carpet or fibrous covers on. All members will be closely positioned next to the base to appear to have a very slender profile that is similar to luggage. The assembly is noticeably light-weight.

One or multiple handles are conveniently positioned along outer edges of the base; depending of which edge is picked up first, for ease of transporting. When a customer grabs the handle, they'll carry the handle comfortably in their hand, which positions the base's flat surface in a vertical axis and parallel to their side as they walk. This invention can be assembled within minutes and placed anywhere there is a flat surface with sufficient vertical height.

Any carpet or fibrous material can cover a member easily, with an ease of removal too. Each platform cover provides two surfaces to be an ‘upper surface’. Each covering for the cylindrical member can also cover the vertical section of another worn-out claw post or scratcher post, provided the covering is a comparable size in height and circumference.

### BRIEF DESCRIPTION OF DRAWINGS

The many features and benefits will be clearly understood when reading these description of drawings, followed by the detailed descriptions.

FIG. 1 shows a frontal view of how the invention is built-up to be used.

FIG. 2 shows a frontal exploded view of the cylindrical structure, its upper collar, its lower stabilizing ring with attaching hardware and the base. FIG. 2, numeral 1 points to adhesive strips on the base as numeral 2 points to the coupler attaching section that is covered by the cylindrical structure . FIG. 2, 110 numeral 3 points to the hole in the base as numeral 4 points to anchor bolts that line-up with the eye-bolts on the cylindrical structure's stabilizing ring; of numeral 8, for exact positioning in the center. Numeral 5 points to the main cylindrical structure as numeral 6 points to the collar that is affixed to the upper end. Numeral 7 points to a stabilizing ring affixed to an area near the lower 115 end of the cylindrical structure.

FIG. 3, numeral 1 shows a frontal exploded view of the inner cylindrical structure fully telescoped from within the main cylindrical structure. Numeral 2 points to the nuts that tighten down over anchor bolts; as seen in FIG. 2, numeral 4, to 120 secure the to the base main cylindrical structure.

FIG. 4 shows a view of the underneath surface of the base as the coupler flange is attached to that surface. FIG. 4, numeral 1 points to the coupler flange's bottom surface and screw heads are seen to show it is attached from below. 125 Numeral 2 points to the lower surface of a shim that is affixed to the lower end of the smaller cylindrical structure. Numeral 3 points to the lower surface of a ring where the rings outer surface is affixed to the inner wall of the main cylindrical structure; at an area near the upper end. Numeral 4 points to the bottom surface of the smaller cylindrical structure that telescopes up.

FIG. 5, numeral 1 shows a cross section of the coupler profile as its flange is attached to the underneath surface of the base and the couplers upper section protrudes through the hole in center of the base. Numeral 2 points to hardware attaching the coupler to the bottom surface of the base. Numeral 3 points to a framework around the base that lifts the base up so the coupler and hardware do not scrape bottom. Numeral 4 points to anchor bolts that are embedded into the base surface and coupler flange to ensure the cylindrical structure is doubly secured to the base. Numeral 5, points the coupler upper section that protrudes through the base hole.

FIG. 6, numeral 1 points to a cross sectional profile of the main cylindrical structure. Numeral 2 points to the cross section of a stop ring as it is affixed to the inside wall of the main cylindrical structure. Numeral 3 points to empty space between the main cylindrical structure and the smaller cylindrical structure. 145 Numeral 4 points to the outer surface of a shim that is typical of the shims attached to the lower end of the smaller cylindrical structure. Numeral 5 points to a nut that is typical of the other nuts. Numeral 6, points to the eye-bolts screwed into the stabilizer ring. Numeral 7 points to the stabilizer ring.

FIG. 7 shows a frontal exploded view of the base, the cylindrical structure with its collar on its upper end, the telescoped cylindrical structure fully extended without its modular collar, and the hinged extender cylindrical structure fully opened; above the telescoped structure. FIG. 7, numeral 1 points to the interior of the hinged cylindrical extending structure in a fully opened position. Numeral 2, points to a shim that is typical of other shims that are affixed to the inner wall. Numeral 3 points to a partial end of one collar when the hinged cylindrical structure is fully open.

FIG. 8, numeral 1 shows a frontal view of the hinged cylindrical structure fully open. Numeral 2 shows collars at various elevations on both half-shells of the hinged cylindrical structure. Numeral 3 shows its locking mechanism; a right angled lever, pointed slightly downward near the outer edge of the left-half shell, at mid-height level. Numeral 4 points to the latching post near the outer edge of the right half-shell, at the same level and opposite its companion latching lever.

FIG. 9, shows a frontal view of the hinged cylindrical structure fully closed and the right-angled lever is holding onto the post to show a locked position.

FIG. 10 shows a plan view of the matted surface that covers the base, multiple adhesive strips, its center hole, and an open seam that extends from the center hole to an outer edge and parallels either side's outer edge.

FIG. 11 shows a plan view of the matted surface of a fibrous cover lying flat and completely open.

FIG. 12 shows both ends of the fibrous cover meet together creating a tube-like form to stand up by itself, while leaving the upper area partially open.

FIG. 13 shows a closer view of the upper area of the partially open area of the cover.

FIG. 14 shows the aft area of a platform cover; where its open area can slide over each platform, a partial view of the upper surface and the rear edge of the lower surface.

FIG. 15, numeral 2 shows a worn-out claw post or scratcher post and shows the cylindrical structure cover is ready to cover the worn-out vertical section of a claw post or scratcher post for.

FIG. 16 shows the fibrous cover of the cylindrical structure is covering a worn-out vertical section on a cat tree.

FIG. 17 shows a left side, perspective view of a platform that is typical of all platforms.

FIG. 18, shows three views of the platform. Numeral 1 shows the platform prong-end and the male portion of a two part snap set. Numeral 2 shows the holding strap aft view and the inner view of the female portion of a two part snap set. Numeral 3 shows the frontal view of holding strap and frontal view of the female portion of a two part snap set.

FIG. 19 points to stabilizing ring and eye portion of eye-bolt that extends from ring's outer surface.

FIG. 20 shows the cylindrical structure on the base as its stabilizing ring is flush with the base surface and an eyebolt surrounds an anchor bolt.

FIG. 21, numeral 1 shows a platform with a “stiffener” inlayed in a surface shown by dotted lines. Numeral 2 shows the stiffener. Numeral 3 shows rectangular inset in surface extending from inner radius to outer edge.

FIG. 22 shows a three point perspective of platform near collar. Numeral 1 shows a three point perspective of platform forks inside collar's open channel. Numeral 2 shows a perspective angle view of strap snapped to forks as FIG. 18, numeral depicts.

FIG. 23 shows a three point perspective of the modular collar. Numeral 1 shows a bottom view of the collar.

### DETAILED DESCRIPTION

It should be noted that the spirit and scope of this invention should not be take in a limiting sense as such embodiments selected for illustrating the details are made merely for the purpose of illustrating the general principles of the invention.

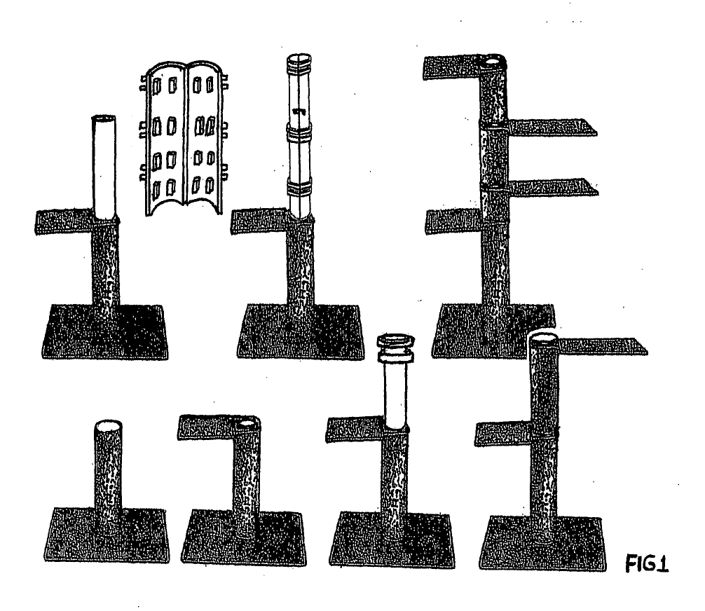

This invention is displayed in a left side, perspective, exploded view as seen in FIG. 1 to reveal how each piece relates to the assembly.

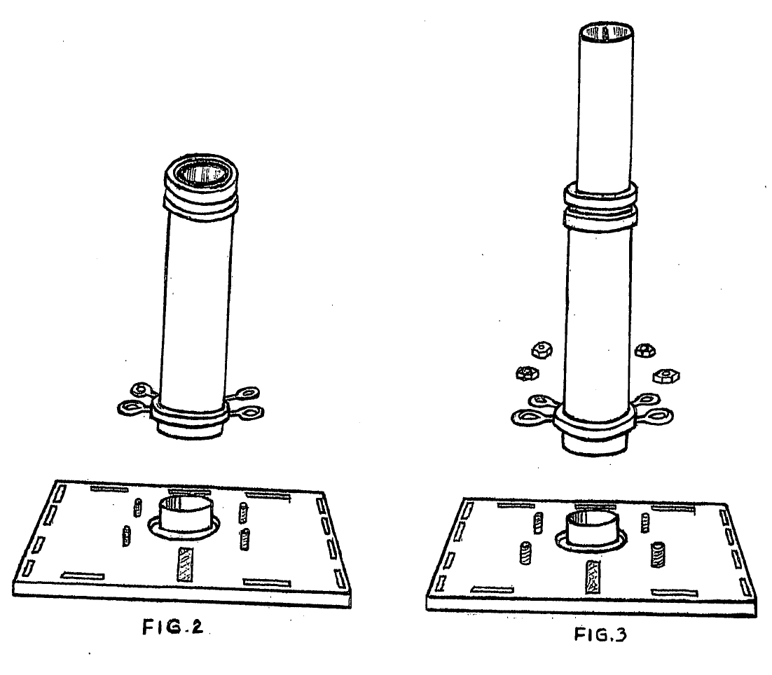

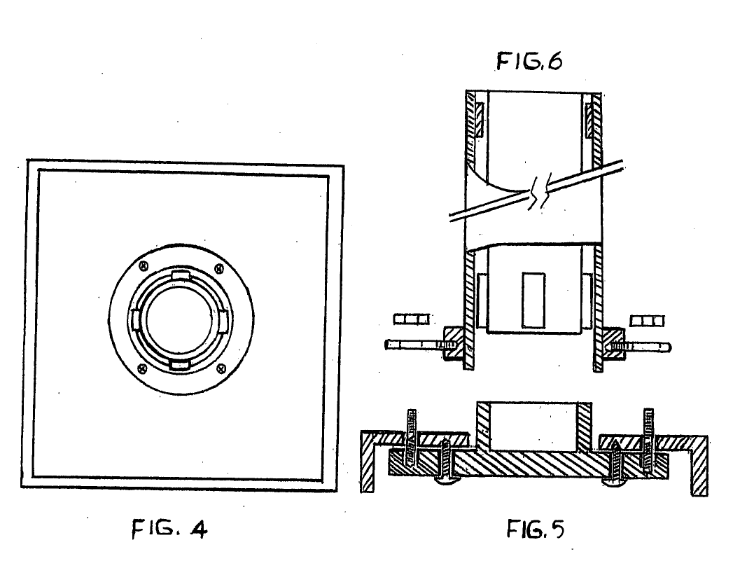

The base supports the entire assembly as seen in FIG. 5. The base's shape and dimension is not limited to the artwork. Materials such as solid wood, plywood, MDF particle board, thick aluminum sheeting, a steel sheet, cement slab, plastic resins or any other materials can be used for the base. The base employs one or a plurality of couplers for positioning one or a plurality of cylindrical structures in an upright posture as seen in FIG. 2, numeral 2.

One or multiple 360 degree holes; which may be circular, oval, or some other shape, are cut through the base FIG. 2, numeral 3 and their diameters are sufficient enough for each coupler's receptive section to pass through easily as seen in FIG. 5, numeral 5.

Each coupler's flange affixes to the underneath surface of the base with screws as seen in FIG. 5, numeral 2, and one end of each cylindrical structure or plurality of structures cover a coupler section with a snug fit.

When a coupler section FIG. 5, numeral 5, is completely covered by the lower end of a cylindrical structure, a stabilizing ring; near the structures lower end, makes contact with and is flush to the base surface; FIG. 3.1.

Numerous eye-bolts extend outward from the stabilizing ring FIG. 2, numeral 8 to be held down by the base anchor bolts; as seen in FIG. 3.1. A nut is turned down on each eye-bolt to hold the stabilizing ring down with ample security to the base.

The inner surface of the ring is affixed to the exterior wall of the cylindrical structure with industrial adhesives, cement, or common hardware, to minimize sideways and fore-aft swaying movements when felines and other small animals are active on the assembly.

Each eye-bolts' proximity from one another is on a horizontal radius plane of an approximate equal distance around the rings perimeter.

One cylindrical structure is identical to other cylindrical structures that may be added to the base. Each cylindrical structure is manually pushed down over its respective coupler and within each main cylindrical structure is a smaller-diameter cylindrical structure, that is manually pulled up by grabbing a handle inside the smaller structure, located somewhere near the upper end, but not shown on the drawings because of its non-consequential significance. The handle can be made of any material.

This smaller-diameter structure is supported in-place by multiple shims [that]are affixed by cement or other adhesive substances to the outer wall of the smaller cylindrical structure. Each shim is on the same horizontal plane with each other, even when considering they are affixed to a tubular shape along its vertical axis. The grouping of shims minimize any wobble affects as they slide up or downward within the hollow cavity of the main cylindrical structure and assure that the smaller structure does not pull out completely, but stops in a straight, upright posture, when the shims stop against the upper ring FIG. 6, numeral 2. When being manually pulled up, the upper ring minimizes any wobble affect as the cylindrical body moves past it.

After the smaller structure is fully extended upwards, a modular collar can be placed [on the upper edge of the telescoped structure; FIG. 3, numeral 1, by sliding either end of the collar, FIG. 3.1 over the top end [until] its upper surface is flush with the upper surface of the telescoped structure.

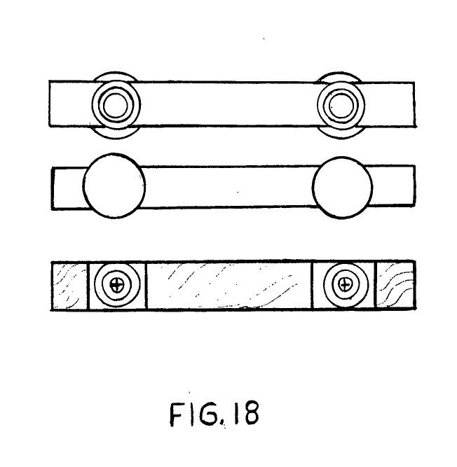

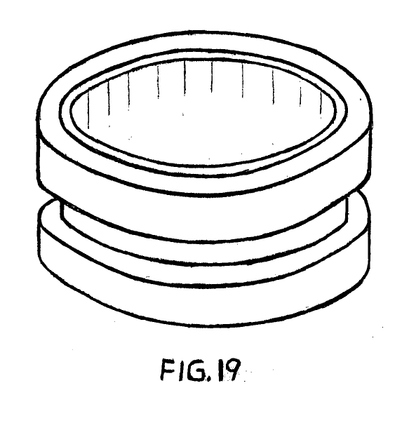

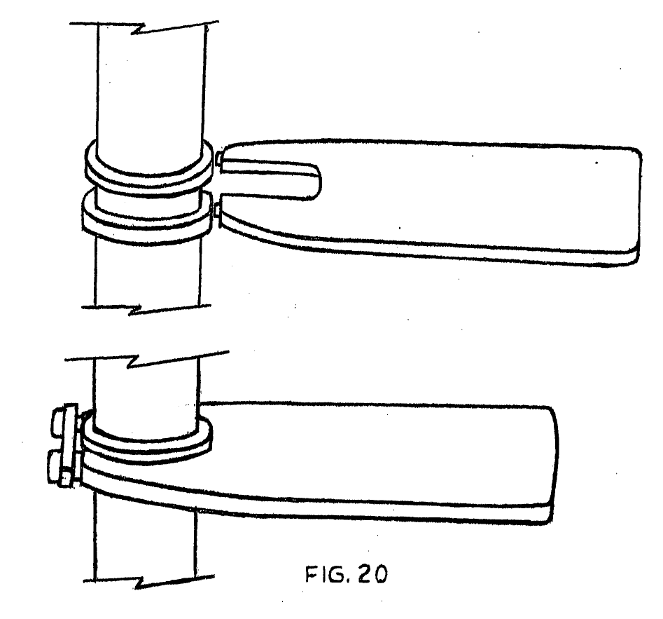

Each collar has a channel or open space, in its middle area; FIG. 3.2. The fork end of a platform slides into that area as seen in FIG. 18, numerals 1 & 2. It can remain still or swivel around the post after a strapped is snapped to the fork end to hold the platform within the collar.

The modular collar, FIG. 3.2 is formed by placing two thick rings on a short hollow tube and leaving a space between them as seen in FIG. 3.2, numeral 1. The tube's inner diameter is large enough to slide over the end of the smaller telescoped structure, with a snug fit; FIG. 2, numeral 6.

The modular collar has to remain off so, a hinged modular cylindrical structure can encapsulate the telescoped member to extend the structures over-all height as seen in FIG. 1, upper right corner image.

The modular cylindrical structure's length is separated in half producing two half shells. A hinge is placed on one side, between the half shell edges to conjoin both shells together, thus producing the hinged modular cylindrical structure. With the hinge in place, both halve-shells are manually moved apart to a wide open position or moved together to close and encapsulate around the smaller-diameter telescoping structure. The hinged modular cylindrical structure is also referred to as the “Hinged Extender” a simplified term describing its purpose of extending the over-all height of the assembly.

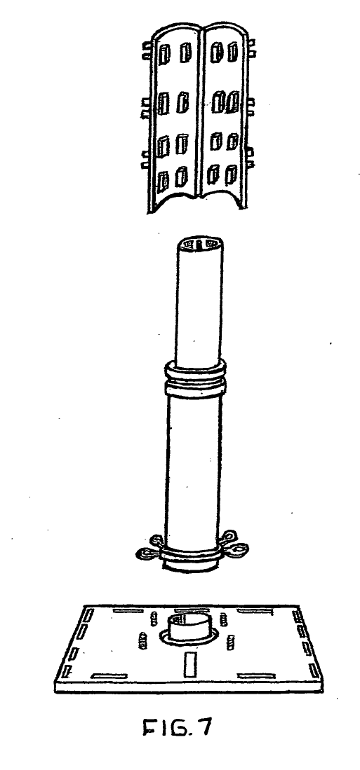

The hinged extender employs multiple collars on its outer wall, at various elevations FIG. 7, numeral 3. Each modular collars' inner surface within its channel is sufficiently smooth to negate any need for bearings.

Within the interior of the hinged extender is a plurality of shims; FIG. 7, numeral 2 that are affixed to its inner wall via cement or other adhesives. Each shim fills-in space between the telescoped structure and the hinged extender. The grouping of shims gives the outer wall a solid feel, when both half-shells encapsulate around the telescoping structure.

A locking lever; that is “L” shaped, is affixed onto the exterior surface of one half-shell; near its outer edge, at location that is a mid-way height. Its inner edge is attached to a hinge. The hinge is not shown on the drawing but can be made of a metal material or other materials that allow both half-shells to open fully and close.

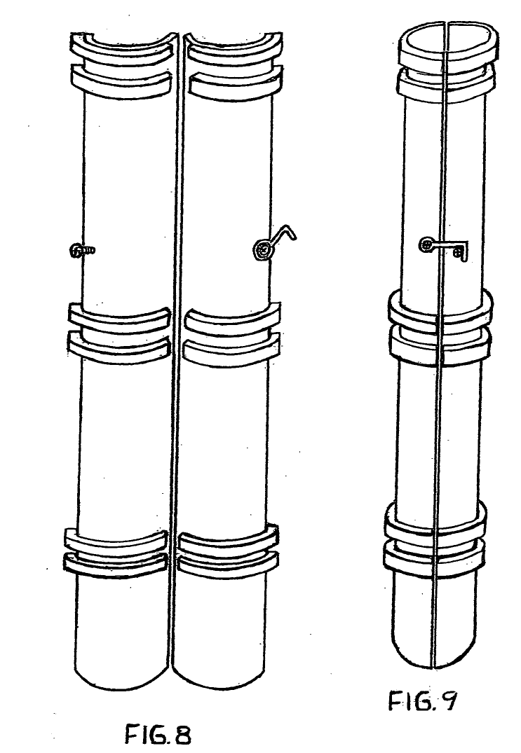

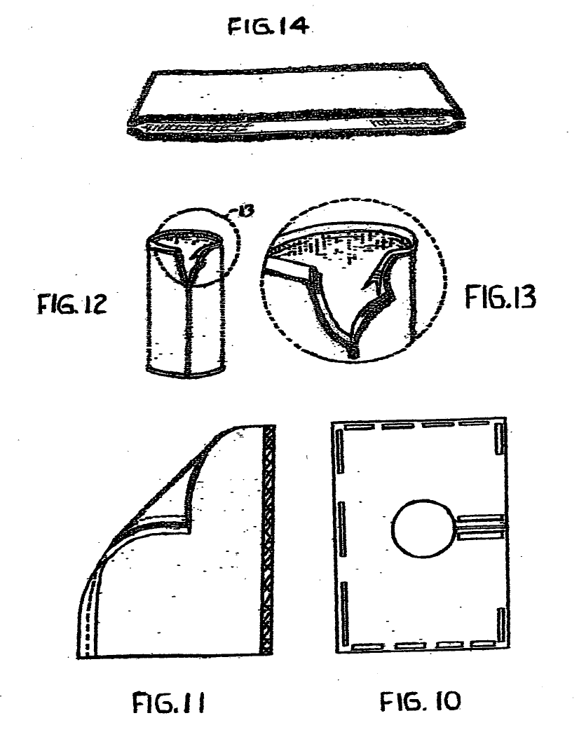

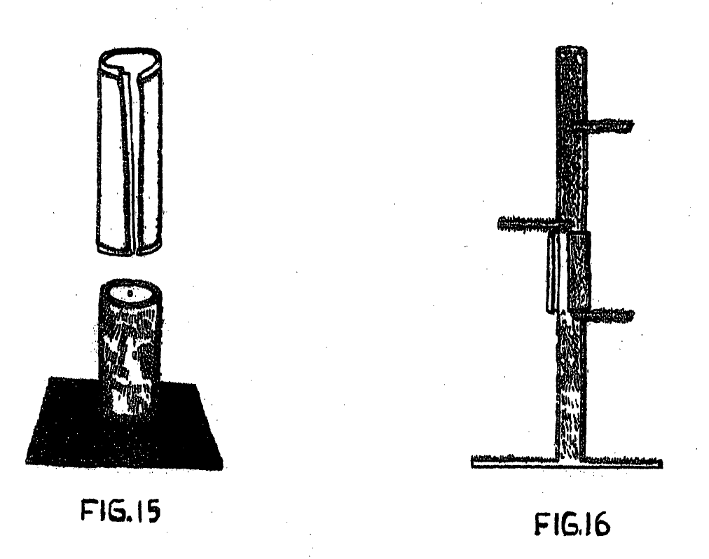

A common screw is inserted threw the eye of the lever to affix the lever to the exterior surface, as seen on FIG. 8, numeral 3. The screw maintains a certain tightness on the lever, to hold it firmly in-place as the lever is manually adjusted in a direction that allows it to hold onto the far side of a threaded stud that is affixed to the exterior surface and same level on the opposite half-shell. This hardware holds both outer edges together for a tight closure as seen in, FIG. 9.

After the modular hinged extender has encapsulated the telescoped structure, one or more platform end-forks can be inserted into each respective collar.

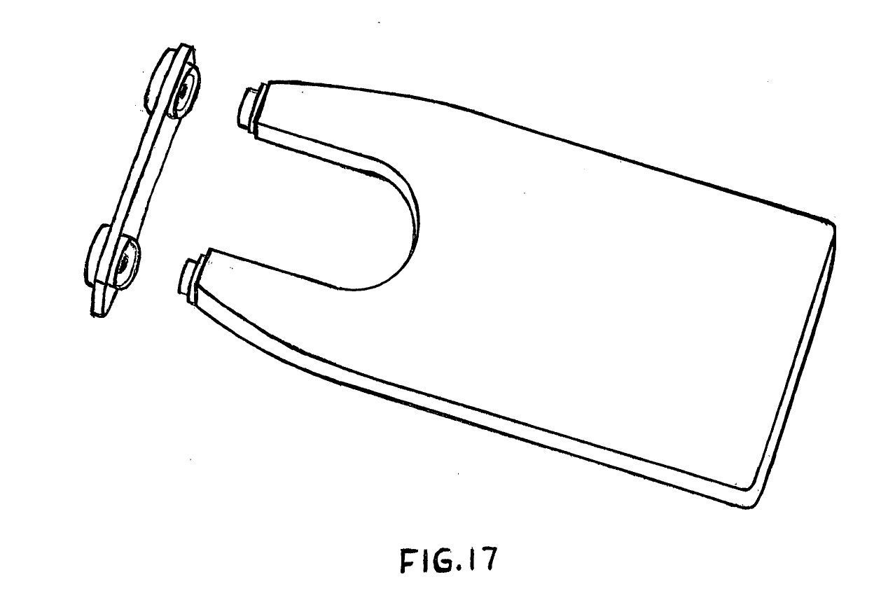

Each end-fork has a connection; the male portion, of a two-part snap connection. Its matching female snap cover is on the ends of a holding strap. The holding straps' length and height is sufficient to hold the end-forks close into each collar and allow for movement within the collars channel for swiveling, FIG. 17. No bearing is necessary for horizontal movement around the collar as the collars surface is sufficiently smooth. Each pair of snaps can be made of metal or any material that is durable. Each strap can be leather, thick plastic or other semi-stiff material.

Each member of this invention can be covered with a fibrous material in the likeness of carpet or sisal rope. The base surface has adhesive strips or a fibrous hook or loop material at random areas for holding onto the bottom surface of its respective cover.

A circular hole and slit along one side is cut through the base covering for allowing the cover to fit easily over the base surface while a cylindrical structure is attached to the base surface. If a plurality of cylindrical structures are added to the base surface, one or multiple coverings are available to cover the base surface while giving space for a plurality of structures. All coverings are replaceable and washable.

The covering for the cylindrical structure has adhesive substances or hook and loop material attached to its matted surface, at both ends so both ends will be held together when they overlap to form a fibrous tube. One end of this tube can be slipped over the upper end of the cylindrical structure and pulled down to the base surface or remain open and flat, to be wrapped around the cylindrical structure, and manually press both ends over each other when over-lapped for closure.

Covers for each platform are shaped [to form a large pocket. The open side is manually positioned for sliding onto the platforms' front edge. As the material is moved over the platform its] material envelops the upper and lower surfaces to cover the platform completely. When the material of one surface is tattered or pulled up too much from a felines claw or other animals use that surface is manually pulled off, flipped or turned over so the lower surface becomes the new upper surface and the cover is slid back on. With exception of the sisal rope material, most covers can be spot washed by hand or a cleaned with any carpet cleaning machine All covers are replaceable.

All cylindrical structures can be made from materials including and not limited to ABS plastics, aluminum pipe, steel pipe, and all other materials that will render strength and flexibility to the entire device. Even though a steel pipe is considered excellent material for strength purposes, its weight will push shipping costs up to equal the retail price and most consumers consider shipping cost before continuing with an order online.

Platforms can be made from but not limited to wood, aluminum, sheet metal, thick plastic or a poly-resin[substance combined with other materials or composites that are formed into unlimited shapes that are flexible and strong. While this invention has been particularly described, in respect to the illustrated embodiments thereof, the foregoing artwork made is without departure from the spirit and scope of the invention.

1. An expandable pet device comprising of a supportive member called the Base, having one or multiple holes; completely through its top-to-bottom surface, of sufficient diameter, where a couplers' upper edge extends through such orifice; at a sufficient height, its side wall area can be available for connection or the coupler's upper edge can remain flush with the base upper surface, resulting in space between the base hole and the couplers' wall upper edge, so when the coupler is unused, it is covered to show a level surface, while the coupler's opposite end shows a flange, that is affixed to the underneath surface of the base, using common metal hardware while other threaded posts are exposed; slightly above the base surface, using a nut for tightening, as these threaded posts are positioned around and distal to each coupler hole, the outer edges of the base can optionally conjoin with other bases for widening purposes.

2. An expandable pet device; of claim one, determines a coupler connects with the bottom end of a hollow, elongated cylindrical structure; for vertical positioning or a plurality of so named cylindrical structures covers each coupler, while a smaller-diameter cylindrical structure rests within such structure(s) as an integral member, for, when unused, it remains hidden, as a platform can be placed in a collar that's affixed atop the larger structure or when such smaller-diameter cylinder is used, the platform can stay in position, while a handle; within and near the upper edge of the smaller cylinder, is pulled up to any elevation towards a total extension, after which a modular collar can be placed on the upper area end, to support a platform, for swiveling in 360 degrees, or the collar remains off, as contrast to the opposite end of the larger cylindrical structure having a square shaped flange, affixed; via cement glue or any mechanical means, in 360 degrees on the cylindrical structure; that is distal to the bottom end, having embedded eye-bolts that are parallel with the base and center area of each eye-bolt aligns perpendicular with center-lines of base threaded posts; of claim one, where each threaded bolt is adjacent to the base coupler hole; of claim one, for a nut turns down on the threaded post, to hold each eye-bolt securely to the base surface.

3. An expandable pet device of claim 2 states a modular collar can remain off, for when off, a modular, hinged, hollow cylindrical structure can open and close around a smaller-diameter telescoped cylindrical structure; of claim 2, to encapsulate it; when fully extended, thus extending the structures over-all height thereby, enabling more platforms to be inserted into collars that are affixed to its outer surface, at various elevations.

4. An expandable pet device of claim 3 depicts the over-all assembly height is increased via the modular hinged cylinder which can remain off but, regardless of what part is put on the assembly, all parts are covered with replaceable fibrous materials and the platform cover, in particular, is formed so the upper and lower surfaces are used as an “upper surface” on said platform for clawing and resting.
